(19) United States
(12) Patent Application Publication
(10) Pub. No.: US 2005/0253496 A1
(43) Pub. Date: Nov. 17, 2005

(54) Electron gun and an electron beam window

(76) Inventors: Adam Armitage, Bath (GB); Alan D. Hart, Bath (GB)

Correspondence Address: NIXON & VANDERHYE, PC, 901 NORTH GLEBE ROAD, 11TH FLOOR, ARLINGTON, VA, 22203, US

(21) Appl. No.: 10/522,240

(22) PCT Filed: Nov. 29, 2004
(86) PCT No.: PCT/GB04/05023

§ 371 Date: Jan. 25, 2005

(30) Foreign Application Priority Data
Dec. 1, 2003 (GB) 0327772.0
Dec. 1, 2003 (EP) 03257560.7

(51) Int. Cl. H05H 1/00

(52) U.S. Cl. 313/359.1

(57) ABSTRACT

An electron beam window 20 is formed with six diamond panes 21 to transmit an electron beam 15. The panes 21 are formed in a cylindrical disc 17 of single crystal or of polycrystalline diamond such that each pane 21 is surrounded by a thicker integral peripheral rim 22 which conducts heat away from the panes 21. A heat sink ring 35 can be fitted to the outer cylindrical surface of the peripheral rim 22. A scanning means 36 indexes the electron beam 15 sequentially through each pane 21. The use of diamond panes reduces the electron beam energy converted to heat in each pane 21, the thicker peripheral rim 22 increases cooling of the panes 21, and the scanning movement 37 reduces the temperature rise of the panes 21.

This invention relates to an electron gun, to an electron beam window and to a method of reducing heating of an electron beam window.

Electron beams are useful in several applications including, for instance, electron beam welding, materials processing, and plasma generation. An electron gun is used to produce such electron beams by accelerating electrons to high velocity whereby the electrons have a high kinetic energy. Such acceleration is essentially carried out in a high-vacuum chamber, typically of 1×10⁻⁶ mBar (millibar).

When the electron beam is to be used in a higher pressure environment, it is necessary to provide the high vacuum chamber with an electron beam window thereby permitting the accelerated electrons to pass from the high vacuum chamber into the higher pressure environment.

Such electron beam window therefore constitutes an interface between the high vacuum chamber and the higher pressure environment and must meet the following criteria:—
1. Sufficient strength to withstand the pressure differential.
2. Allow the passage of the accelerated electrons.
3. Have minimal electron beam absorption.
4. Be able to withstand the temperature rise occurring during transmission of the electron beam

An electron passing through a thin layer of material loses energy by collisional scattering processes in accordance with Bethe's equation:

$$\frac{ⅆ E}{ⅆ x} ∝ \frac{Z ρ}{A} 1 n ( \frac{E}{I} )$$

This states that the rate of energy loss

$$\frac{ⅆ E}{ⅆ x}$$

is proportional to the atomic number Z and the density ρ of the material the electrons pass through, is inversely proportional to the atomic mass A, and is proportional to the log of the ratio of the electron energy E to the atomic ionisation energy I.

In order to minimise energy loss, the most suitable materials for forming an electron beam window have been chosen from those having a low density and consequently low electron energy absorption. It is also recognised that the window material must also have good mechanical properties so that the window can be as thin as possible to minimise energy loss in the window.

The energy absorbed by the electron beam window causes its temperature to increase all the time that the electron beam is being transmitted. For this reason the thermal characteristics of the material forming the electron beam window are preferably a high thermal conductivity K so that heat will be conducted away as quickly as possible, also a high specific heat capacity so that the temperature rise for a given absorbed energy will be relatively low, and a high maximum service temperature to extend the time during which the electron beam may be transmitted without causing thermal damage.

Conventionally an aluminium beryllium alloy has been employed for forming electron beam windows and typically has the following properties:—

| | |
|---|---|
| Density, ρ | 2122/kg/m³ |
| Thermal conductivity, K | 246 W/m/K |
| Specific heat capacity | 1675 J/kg/K |
| Maximum service temperature | 610 K |
| Tensile strength | 447 MPa |

The tensile strength of a typical aluminium beryllium alloy enables a 10 mm pane to be formed from a 36 micron foil to withstand a pressure differential of one atmosphere. At this foil thickness approximately 15% of the energy of a 125 KeV electron beam will be absorbed by the pane and the thermal loading associated with this rate of absorption limits the use of an aluminium beryllium pane to either a pulsed electron beam system, or a very low current continuous electron beam system.

JP Patent Application 02-138900 teaches that an electron beam window for an electron microscope can be a diamond-like film or a diamond film formed by a process such as a hot filament CVD, plasma CVD, combustion flame CVD or electron beam CVD.

U.S. Patents 2002/0048344 and 2002/0048345 use a diamond foil in a composite window for an electron beam in an x-ray generator.

U.S. Pat. No. 5,235,239 recognises the need to remove accumulated heat, from a diamond foil window, to keep the foil from disintegrating or rupturing as a result of melting or softening, and provides a water cooling system.

Until quite recently the choice of an exotic material, such as diamond, has been out of the question due to the inherent cost. Although the specific heat capacity of diamonds is typically 400 J/Kg/K (only one quarter of that of aluminium beryllium alloy), diamond has a higher density of 3,580 Kg/m³ and very much higher thermal conductivity (2400 W/m/K), maximum service temperature (2000 K), and tensile strength (2930 MPa). Due to its exceptional mechanical strength and its ability to withstand extremely high temperatures, a 10 mm diamond pane can be formed with a thickness of only 3.1 microns to withstand a pressure differential of one atmosphere. This reduction in thickness leads to an absorption of only 2% of the energy of a 125 KeV electron beam. Furthermore the much higher thermal conductivity makes it possible for heat generated by this energy loss to be conducted away from the pane at a much higher rate. The higher rate of thermal conduction, combined with the extremely high maximum temperature, enables the electron beam to be transmitted without interruption for a very much longer period than has hitherto been possible.

The present invention is concerned with improving the performance of an electron beam window, and an electron gun using such an improved window.

According to one aspect of the invention an electron gun is arranged to produce an electron beam within a vacuum chamber and to direct the electron beam through an electron beam window into a region of higher pressure, and includes means to cause relative movement between the electron beam and the electron beam window to limit heating of the portion of the electron beam window transmitting the electron beam. The electron beam window is preferably formed from diamond. The electron beam window is preferably carried by a support arranged to dissipate heat generated by the passage of the electron beam through the window.

The electron beam window may comprise a single pane having a transverse dimension that is more than twice the transverse dimension of the electron beam, and the means to cause relative movement is a scanning means operable to cause continuous relative movement between the electron beam and the pane, whereby the electron beam will be transmitted through changing areas of the pane. The dimension may be the diameter of a circular area of the pane, and the scanning means may cause the electron beam to orbit around this circular area.

Alternatively the scanning means may be arranged to cause the electron beam to perform a raster scan across the pane.

Alternatively the electron beam window may comprise a plurality of panes and the means to cause relative movement is a scanning means operable to cause relative indexing between the electron beam and the plurality of panes whereby the electron beam will be transmitted for a limited time by each pane in sequence.

The scanning means is preferably magnetic and operable to move the electron beam relative to the electron beam window.

According to another aspect of the invention, an electron beam window comprises a plurality of diamond panes which are each of a size to transmit an electron beam, and the panes are carried by a support arranged to dissipate heat generated in any of the panes by the passage of an electron beam.

Preferably the support is connected to a heat sink. In this case the heat sink may be secured to at least one surface of the support without obscuring the panes. The support may comprise a diamond disc that defines the panes and has an integral rim.

Alternatively an electron beam window may comprise a single diamond pane which has a transverse direction that is more than twice the transverse direction of the electron beam, the pane is carried by a support arranged to dissipate heat generated in the pane by the passage of the electron beam, and the support comprises a diamond disc that defines the pane and has an integral rim. The heat sink may be shrunk onto the rim. Preferably the heat sink is diffusion bonded to the rim.

According to a further aspect of the invention, a method of reducing the heating of an electron beam window comprises moving the electron beam relative to the electron beam window.

In the case where the electron beam window comprises a single pane having a transverse dimension that is more than twice the transverse dimension of the electron beam, the method may comprise causing continuous relative movement transversely between the electron beam and the pane.

In the case where the electron beam window comprises a plurality of panes, the method may comprise indexing the electron beam relative to the panes whereby the electron beam will be transmitted for a limited time by each pane in sequence.

The invention will now be described, by way of example only, with reference to the accompanying diagrams in which:—

FIG. 1 is a diagrammatic longitudinal section through an electron gun illustrating the position of its electron beam window;

FIG. 2 is an axial view of one form of electron beam window.

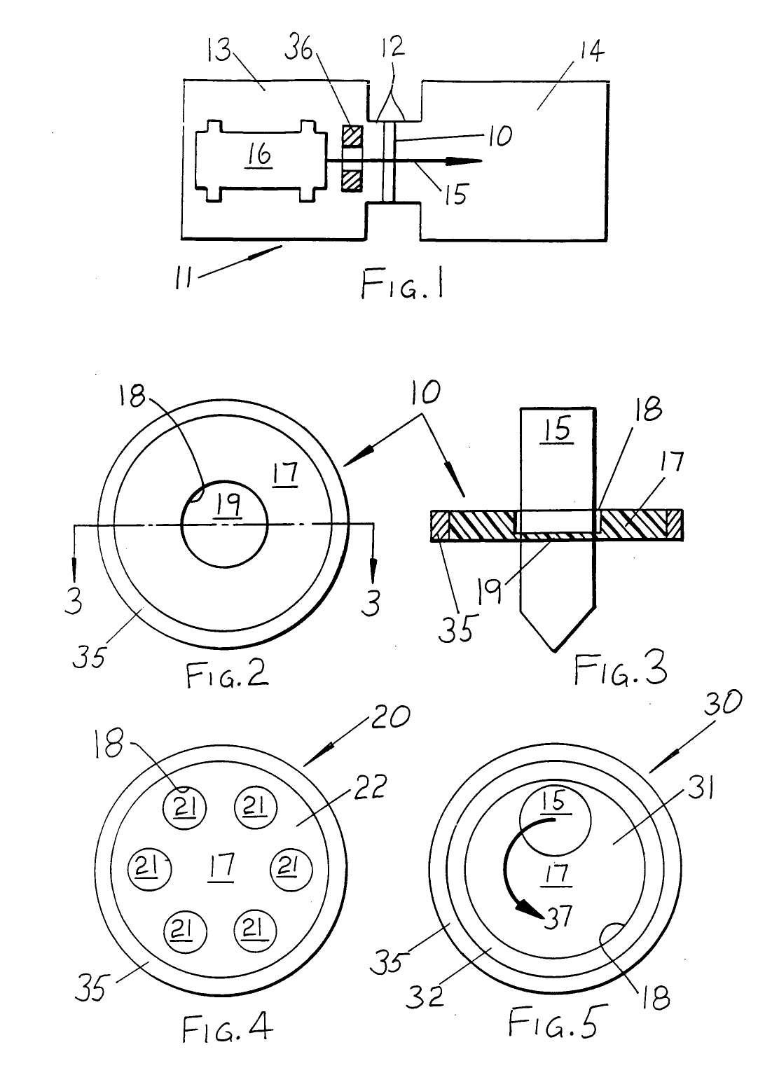

FIG. 3 is a diametrical section taken along the line 3-3 in FIG. 2;

FIG. 4 is a an axial view of one form of electron beam window as taught by the present invention;

FIG. 5 is an axial view of a another form of electron beam window as taught by the present invention;

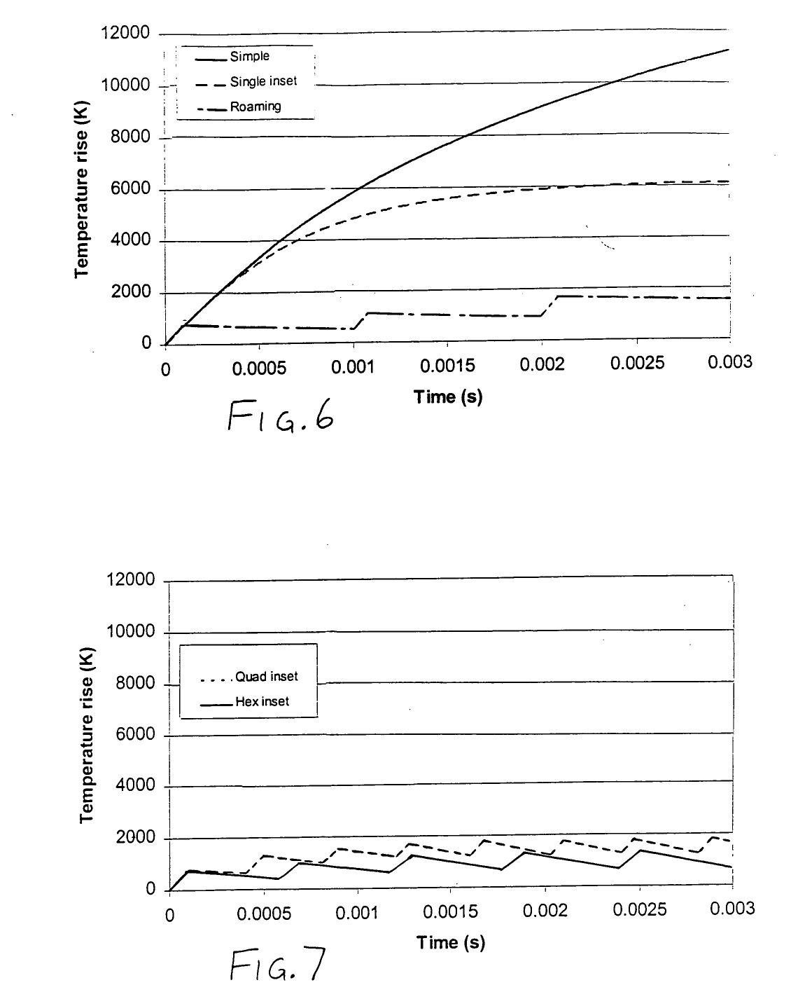

FIG. 6 is a graph of computed temperature rise against time showing the improved performance achieved by the electron beam windows illustrated in FIG. 5;

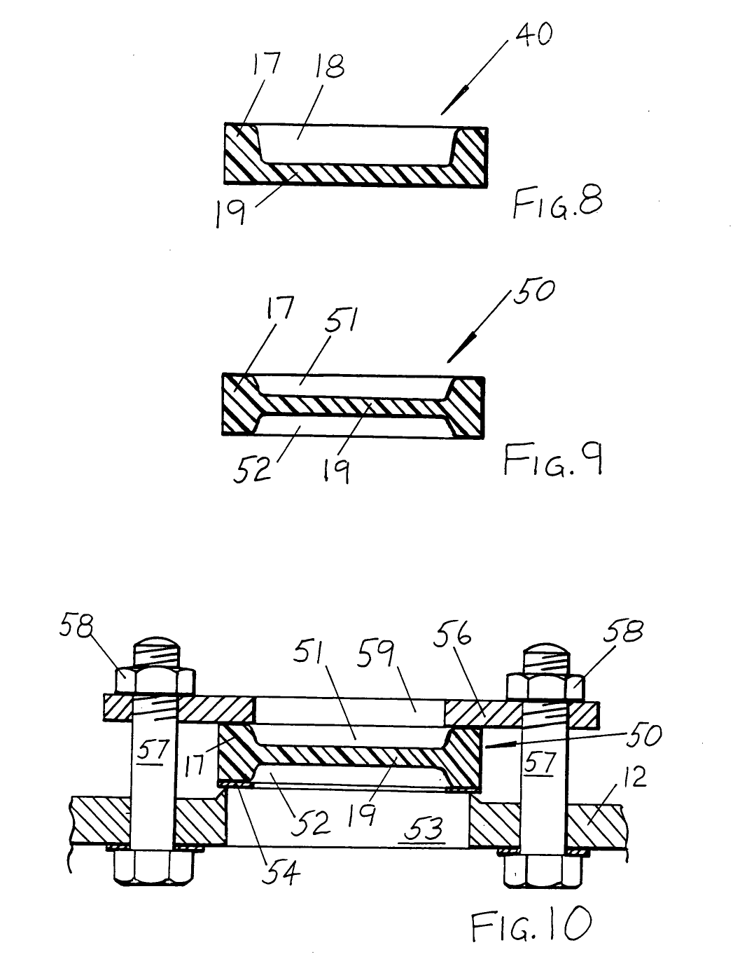

FIG. 7 is a graph similar to FIG. 6 but showing the improved performance of an electron beam window having 6 panes as shown in FIG. 4, and also of a similar electron beam window provided with only four panes;

FIG. 8 is a diametrical section through another form of electron beam window;

FIG. 9 illustrates a modification of the electron beam window illustrated in FIG. 8, and

FIG. 10 illustrates the mounting of the electron beam window shown in FIG. 9 to a support structure within an electron gun.

With reference to FIG. 1, an electron beam window 10 is positioned inside a typical electron gun 11 with its periphery supported from a structure 12 which connects a vacuum chamber 13 to a chamber 14 that is to receive an electron beam 15 from an electron beam generator 16. The vacuum chamber 13 is evacuated to generate a vacuum of typically 10⁻⁶ mb. The chamber 14 defines a region of higher pressure, as is well known in the art, the electron beam window 10 serving as a physical barrier to preserve the pressure difference between the chambers 13 and 14. Consequently, the electron beam window 10 must withstand a force equal to its cross sectional area times the pressure difference between chambers 13 and 14, this force being transmitted to the structure 12.

With reference to FIGS. 2 and 3, the electron beam window 10 is formed from a cylindrical disc 17 of polycrystalline diamond manufactured by chemical vapour deposition or by any other convenient process. The cylindrical disc 17 is approximately 1 mm thick and has a central cylindrical depression 18 formed by ion beam etching. The formation of the cylindrical depression 18 is carefully controlled so that a 10 micron thick pane 19 is left having a diameter of about 10 mm to match the diameter of the electron beam 15. In this manner the pane 19 is formed integral with the thicker annular portion of the cylindrical disc 17 which constitutes a support for the pane 19 in the form of a peripheral rim serving as a heat sink. This diamond rim serves as a thermal transport substrate which, due to its high thermal conductivity and integral formation with the pane, provides exceptionally high transfer of thermal energy away from the pane. The thickness of the peripheral rim is therefore selected to be sufficient to dissipate heat generated in the pane by the passage of an electron beam. If desired, the rim may be connected to a heat sink which is preferably shrunk onto the rim and is diffusion bonded to it. The integral construction ensures excellent conductivity to dissipate the heat generated by the passage of the electron beam 15 through the pane 19. By using this single inset pane 19, the thermal loading capability of the electron beam window 10 is improved because the thickness of the pane 19 is minimised whilst the remainder of the cylindrical disc 17 provides increased thermal conduction. This design is most efficient when the diameter of the pane 19 equals the diameter of the electron beam 15. Alternatively, the peripheral rim may be mounted in a support frame which may constitute the heat sink.

FIG. 4 illustrates an alternative electron beam window 20 in which the cylindrical disc 17 of polycrystalline diamond has been ion beamed etched to define six separate panes 21 of equal thickness and diameter, the disc 17 constituting a support for the panes 21 in the form of a common peripheral rim 22 serving as a heat sink. Alternatively the diamond panes 21 may be mounted in a support frame.

FIG. 5 illustrates another electron beam window 30 in which the cylindrical disc 17 of polycrystalline diamond has been ion beam etched to define a single pane 31 having a diameter that is more than twice the transverse dimension of the electron beam 15. In this manner, the single pane 31 is surrounded by a much thicker integral peripheral rim 32 which constitutes a support for the pane 31 and serves as a heat sink. Alternatively the diamond panes 21 may be mounted in a support frame.

Although the thicker portion of the cylindrical discs 17 shown in FIGS. 2 to 5 serves as a heat sink, the overall thermal capacity can be increased by fitting a heat sink ring 35 to the outer rim of the cylindrical disc 17 as shown in FIGS. 2 and 3, or to the outer cylindrical surface of the peripheral rims 22 and 32 as respectively shown in FIGS. 4 and 5. Such heat sink ring 35 is preferably made as a copper ring shrunk onto the disc 17 and diffusion bonded to ensure excellent thermal conduction. If desired, a heat sink could alternatively or additionally be secured to any other surface of the discs 17 provided that it did not obscure the pane 19 or 31, or the panes 21 to the passage of the electron beam 15. Instead of being made of copper, the heat sink 35 could be formed of aluminium or any other appropriate material.

With the electron beam window 10 described with reference to FIGS. 1 to 3, the electron beam 15 is simply directed through the pane 19 and the energy absorbed by the pane 19 is conducted radially outwardly into the integral thicker portion of the cylindrical disc 17, and then into the heat sink ring 35. The dotted graph in FIG. 6 shows the calculated temperature rise in degrees Kelvin plotted against time, for an electron beam of 31.25 kw passing through a 10 μm pane of 5 mm diameter formed integral with a cylindrical disc 17 that is 1 mm thick and has a diameter of 32 mm. The full-line graph in FIG. 6 shows the calculated characteristic for a nominal pane of the same thickness but with a diameter of 32 mm. Consequently the vertical gap, between the full-line and dotted line graphs in FIG. 6, indicates the extent of the benefit gained by the increased thickness of the outer annular portion of the cylindrical disc 17. However, a comparable characteristic for a conventional aluminium beryllium alloy would be very much steeper than the full-line graph in FIG. 6. It will therefore be understood that the provision of a simple diamond pane without a thicker peripheral rim achieves a substantial improvement over a similar pane made of aluminium beryllium alloy, and also that the provision of the thicker integral peripheral rim achieves a further substantial improvement. However, in both cases, the graphs very quickly exceed the 2000 k maximum service temperature of diamond and show that these constructions are only useful for the transmission of an electron beam for a very short time, or of substantially lower power.

A further significant improvement is achieved by the designs of electron beam windows 20 and 30 respectively illustrated in FIGS. 4 and 5, together with the modification of the electron gun 10 to provide relative movement between the electron beam 15 and the windows 20 and 30. This relative movement is achieved by a scanning means 36 positioned within the vacuum chamber 13 as indicated generally in FIG. 1.

The use of the electron beam window 30 of FIG. 5 requires the electron beam 15 to be moved continuously relative to the pane 31 by the scanning means 36. This design necessitates the use of an oversized pane 31 but reduces the thermal loading whilst increasing thermal dissipation. In FIG. 5, this relative movement is indicated by arrow 37 and is such that the electron beam 15 is continuously transmitted through changing areas of the pane 31. As shown, the diameter of the pane 31 is more than twice that of the electron beam 15 so that the scanning means 36 will sweep the electron beam 15 progressively over fresh areas of the pane 31 until it starts to overlap its original location which, in the meantime will have been cooled by conduction through the integral peripheral rim 32 and, if fitted, into the heat sink ring 35. The chain-dotted graph in FIG. 6 shows the calculated temperature rise in the pane 31 caused by an electron beam of the same power, the pane 31 being 10 mm in thickness with a diameter of 17.5 mm within an integral peripheral rim 32 of 32 mm diameter, the scanning rate being 1 KHz. It is very noticeable that the chain-dotted graph remains, at all times shown, below the 2000° K maximum service temperature of diamond, and that the steps in the chain-dotted graph correspond with completion of each rotary cycle of the electron beam 15 around the pane 31. The temperature is computed at the centre of the window 31. By appropriately balancing the speed of relative rotation and the proportions of the integral peripheral rim 32 (and the conductivity of the heat sink ring 35, if fitted) with the power of the electron beam 15, it is clear that continuous transmission of an electron beam 15 in excess of 30 kw can be achieved. Also that a substantially higher power electron beam 15 could be transmitted intermittently.

The design of electron beam window 20 accommodates electron beams 15 of differing diameter.

If desired, different scanning patterns may be achieved using the scanning means 36, for instance raster-scanning. In the latter case the pane 31 could be of a different shape.

The electron beam window 20 shown in FIG. 4 (hereinafter called the “Hex inset”) has its six panes 21 scanned by using the scanning means 36 to index the electron beam 15 sequentially through each pane 21. The electron beam 15 is therefore transmitted through each pane 21 until its temperature approaches a safe level below the maximum service temperature, and is then quickly indexed to the next pane 21. The full-line graph in FIG. 7 shows the calculated temperature rise in degrees Kelvin, plotted against time, for an electron beam 15 of the same power passing sequentially through the six 10 μm panes 21 of a Hex inset electron beam window 20, each pane 21 being 6.5 mm in diameter with a common peripheral rim 22 having a diameter of 32 mm, the dwell time on each of the panes 21 being 100 μs. From this full-line graph it will be noted that the steps correspond with the movement of the electron beam 15 across the material of the peripheral rim 22 whilst indexing between adjacent panes 21. During this movement a greater proportion of the energy of the electron beam 15 is lost in the thicker material of the peripheral rim. It is clearly beneficial either to minimise the indexing time, or to switch the electron beam 15 off whilst indexing is occurring.

The dotted graph in FIG. 7 shows the calculated performance of another electron beam window, similar to the Hex inset but provided with only four panes of 4.5 m diameter (hereinafter termed the “Quad inset”). It will be seen that, after the first relative rotation, the temperature profile of the Quad inset has stabilised comfortably below the 2000° K maximum service temperature.

Both the Hex inset and the Quad inset enable an electron beam to be transmitted almost continuously, that is as a continuous series of high efficiency transmissions interspersed either by very short transmission breaks of by very short intervals of lower efficiency transmission.

As well as the Hex inset and the Quad inset, the design of electron beam window illustrated in FIG. 4 may be modified to have any number N of panes 21. This use of multiple panes 21 reduces the thermal load on each pane 21 because it will experience a thermal duty cycle of only 1/N.

FIG. 8 illustrates in greater detail the physical features of an electron beam window 40 comprising, for example, a cylindrical diamond disc 17 very similar to that already described and illustrated in FIGS. 2 and 3. The same reference numerals have been used to identify equivalent features and only the points of difference will be described. As will be seen from FIG. 8, the central cylindrical depression 18 is etched by an ion beam to have gently rounded corners to avoid forming any stress raisers that could otherwise lead to cracking as the temperature varies. The cylindrical wall of the depression 18 is formed to be slightly frusto-conical.

FIG. 9 illustrates another electron beam window 50 comprising a cylindrical diamond disc 17 which differs from that shown in FIG. 8 only by the pane 19 being generated partly by a shallower central cylindrical depression 51 in the upper face (as seen in the drawing) of the disc 17, and partly by a shallow central cylindrical depression 52 in the lower face of the disc 17. In this manner both surfaces of the pane 19 are shaped by ion beam etching, or by any other appropriate process, and the pane 19 forms a web extending from the middle of the cylindrical disc 17, thereby providing balanced heat conduction for the upper and lower faces of the pane 19.

In FIG. 10 the electron beam window 50, described with reference to FIG. 9, is shown mounted to the structure 12 separating the vacuum chamber 13 from the chamber 14 as shown in FIG. 1.

The structure 12 is a cast web of stainless steel formed with a cylindrical orifice 53 through which the electron beam will pass towards the pane 19. The electron beam window 50 has an annular copper sealing gasket 54 which is trapped between the cylindrical disc 17 and an annular edge 55 formed integral with the structure 12.

In order to withstand the force created by the differential pressure across the electron beam window 50, a bracket 56 is slidably mounted on an array of stainless steel bolts 57 and is urged against the electron beam window 50 by corresponding locknuts 58. The bracket 56 is formed with a central aperture 59 to allow free passage of the electron beam. As the heads of the bolts 57 are within the vacuum chamber 13, they are provided with respective copper sealing washers as shown.

The various configurations of electron beam window 10, 20, 30, 40 and 50 described herein all offer significant advantages over the plain window configurations and traditional materials hitherto used.

These configurations fabricated from diamond allow increased electron beam current to be transmitted and permit improvements amounting to at least one order of magnitude. In particular they allow continuous electron beam transmission at high currents and higher electron beam transmission efficiency than hitherto.

The diamond pane is preferably formed by chemical vapour deposition as this is very much less costly than using natural diamond. Various methods are known for the synthetic production and shaping of diamond. For instance, U.S. Pat. Nos. 5,264,071 and 5,349,922 teach the production of monolithic diamond sheet by passing a mixture of hydrogen and a hydrocarbon at high temperature over a cooled substrate on which diamond is deposited.

The thickness of the or each pane should be sufficient to withstand a predetermined pressure differential across the pane. The thickness of the pane may typically be between 25 microns and 5 microns and is preferably about 10 microns.

Although the or each pane may be a single diamond crystal, it may be polycrystalline. Use of polycrystalline diamond provides a substantial improvement over aluminium beryllium but, where cost permits, single crystal diamond provides a very much larger improvement.

As diamond is non-toxic and non-hazardous, it is an environmentally friendly alternative to the beryllium which is traditionally used despite the hazards to personnel during both manufacture and replacement of electron beam windows.

1-6. (canceled)

7. An electron beam window comprising a plurality of diamond panes which are each of a size to transmit an electron beam, and the panes are carried by a support arranged to dissipate heat generated in any of the panes by the passage of an electron beam.

8. An electron beam window, according to claim 7, in which the support is connected to a heat sink.

9. An electron beam window, according to claim 8, in which the heat sink is secured to at least one surface of the support without obscuring the panes.

10. An electron beam window, according to claim 7, in which the support comprises a diamond disc that defines the panes and has an integral rim.

11. An electron beam window comprising a single diamond pane which has a transverse direction that is more than twice the transverse direction of the electron beam, the pane is carried by a support arranged to dissipate heat generated in the pane by the passage of the electron beam, and the support comprises a diamond disc that defines the pane and has an integral rim.

12. An electron beam window, according to claim 10, in which a heat sink is shrunk onto the rim.

13. An electron beam window, according to claim 12, in which the heat sink is diffusion bonded to the rim.

14. (canceled)

15. An electron gun, provided with an electron beam window according claim 7.

16. A method of reducing the heating of an electron beam window by an electron beam in an electron gun, comprising moving the electron beam relative to the electron beam window.

17. A method, according to claim 16 and in the case where the electron beam window comprises a single pane having a transverse dimension that is more than twice the transverse dimension of the electron beam, comprising causing continuous relative movement transversely between the electron beam and the pane.

18. A method, according to claim 16 and in the case where the electron beam window comprises a plurality of panes, comprising indexing the electron beam relative to the panes whereby the electron beam will be transmitted for a limited time by each pane in sequence.

19. (canceled)

20. An electron beam window, according to claim 11, in which a heat sink is shrunk onto the rim.

21. An electron beam window, according to claim 20, in which the heat sink is diffusion bonded to the rim.

22. An electron gun comprising an electron beam window positioned between a vacuum chamber and a higher pressure chamber, said electron gun being operable to produce an electron beam within said vacuum chamber and to direct said electron beam through said electron beam window into said higher pressure chamber, and means operable to cause relative movement of said electron beam laterally of said electron beam window to limit heating of the portion of the electron beam window transmitting the electron beam.

23. An electron gun, according to claim 22, in which the electron beam window is formed from diamond.

24. An electron gun, according to claim 22, in which the electron beam window is carried by a support arranged to dissipate heat generated by the passage of the electron beam through the window.

25. An electron gun, according to claim 22, in which the electron beam window comprises a single pane having a transverse dimension that is more than twice the transverse dimension of the electron beam, and said means to cause relative movement is a scanning means operable to cause continuous relative movement between the electron beam and said pane, whereby the electron beam will be transmitted through changing areas of the pane.

26. An electron gun, according to claim 22, in which the electron beam window comprises a plurality of panes, and said means to cause relative movement is a scanning means operable to cause relative indexing between the electron beam and said plurality of panes, whereby the electron beam will be transmitted for a limited time by each pane in sequence.
